(19) United States
(12) Patent Application Publication
(10) Pub. No.: US 2014/0317598 A1
(43) Pub. Date: Oct. 23, 2014

(54) AUTOMATING THE ANALYSIS OF APPLICATION LIFECYCLE MANAGEMENT DATA FOR SOFTWARE DEVELOPMENT

(71) Applicant: INTERNATIONAL BUSINESS MACHINES CORPORATION, Armonk, NY (US)

(72) Inventors: Monica Luke, Somerville, MA (US); Carolyn Pampino, Newton, MA (US)

(73) Assignee: International Business Machines Corporation, Armonk, NY (US)

(21) Appl. No.: 13/866,127

(22) Filed: Apr. 19, 2013

Related U.S. Application Data
(63) Continuation of application No. 13/864,629, filed on Apr. 17, 2013.

(51) Int. Cl. G06F 9/44

(52) U.S. Cl. CPC G06F 8/70
USPC 717/120

(57) ABSTRACT

A computer analyzes application lifecycle management data to calculate waste and inefficiency. The computer receives application lifecycle management (ALM) data that includes workflow artifacts, workflow artifact states, and linkage between the workflow artifacts. The ALM data also includes time stamps associated with the workflow artifacts and linkages. The computer calculates lag time between the time stamps of the ALM data. The lag times measure the timeliness of collaboration and communication within a software development project, and based on the calculated lag times or averages, the computer generates visualizations including value steam maps, lag time visualizations or waste reduction visualizations. These visualizations can monitor the performance of a team or can be used to compare the performance of multiple teams throughout a software development project.

### CROSS REFERENCE TO RELATED APPLICATION

This application is a continuation of U.S. patent application Ser. No. 13/864,629 filed Apr. 17, 2013 the entire content and disclosure of which is incorporated herein by reference.

### FIELD OF THE INVENTION

The present invention relates generally to the field of application lifecycle management data analysis and more particularly to the automated generation of value stream maps and other visualizations in a software development environment.

### BACKGROUND OF THE INVENTION

A value stream is a sequence of activities required to design, produce, and provide a specific good or service, and along which materials and information flow. Value stream mapping is a lean manufacturing technique used to analyze and design the flow of materials and information required to bring a product or service to a consumer. Value stream maps are commonly used to identify and eliminate wasteful practices. A current state value stream map, typically manually prepared ad-hoc by personnel on the shop floor, shows the current steps, delays, and information flows required to deliver the target product or service. A manual approach of generating the value stream map is commonly used to deepen understanding of the value steam by the participants and to provide a snapshot as to the amount of time required by the various tasks.

Value stream mapping software is a type of software that helps prepare and/or analyze value stream maps. The software typically helps design maps through utilizing a series of symbols representing activity and information/material flow, and as a supplement to manual calculations.

Application Lifecycle Management (ALM) is a continuous process of managing the life of a software application. An ALM system represents tasks, and provides the linkages between tasks, in a software development project.

### SUMMARY

Embodiments of the present invention provide for a program product, system, and method in which a computer analyzes application lifecycle management data to calculate waste and inefficiency. The computer receives application lifecycle management (ALM) data that includes workflow artifacts, workflow artifact states, and linkage between the workflow artifacts. The ALM data also includes time stamps associated with the workflow artifacts and linkages. The computer calculates lag time between the time stamps of the ALM data. The lag times measure the timeliness of collaboration and communication within a software development project, and based on the calculated lag times or averages, the computer generates visualizations including value steam maps, lag time visualizations or waste reduction visualizations. These visualizations can monitor the performance of a team or can be used to compare the performance of multiple teams throughout a software development project.

### BRIEF DESCRIPTION OF THE SEVERAL VIEWS OF THE DRAWINGS

FIG. 1 is a block diagram illustrating a software development environment in accordance with an embodiment of the present invention.

FIGS. 2a and 2b show block diagrams of software workflows in accordance with an embodiment of the present invention.

FIG. 3 is a flowchart showing the operational steps of a monitoring program in accordance with an embodiment of the present invention.

FIGS. 4a and 4b show example visualizations generated by a monitoring program in accordance with an embodiment of the present invention.

FIG. 5 is a block diagram of a computer system in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

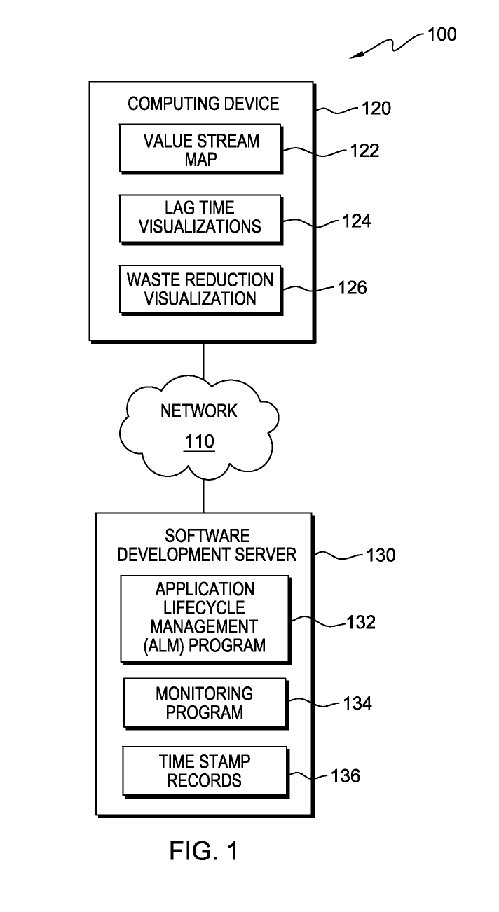

The present invention will now be described in detail with reference to the Figures. FIG. 1 is a block diagram illustrating software development environment 100, in accordance with one embodiment of the present invention. Software development environment 100 includes network 110, computing device 120 and software development server 130. Network 110 can be, for example, a local area network (LAN), a wide area network (WAN) such as the Internet, or a combination of the two, and can include wired, wireless, or fiber optic connections. In general, network 110 can be any combination of connections and protocols that will support communications between computing device 120 and software development server 130.

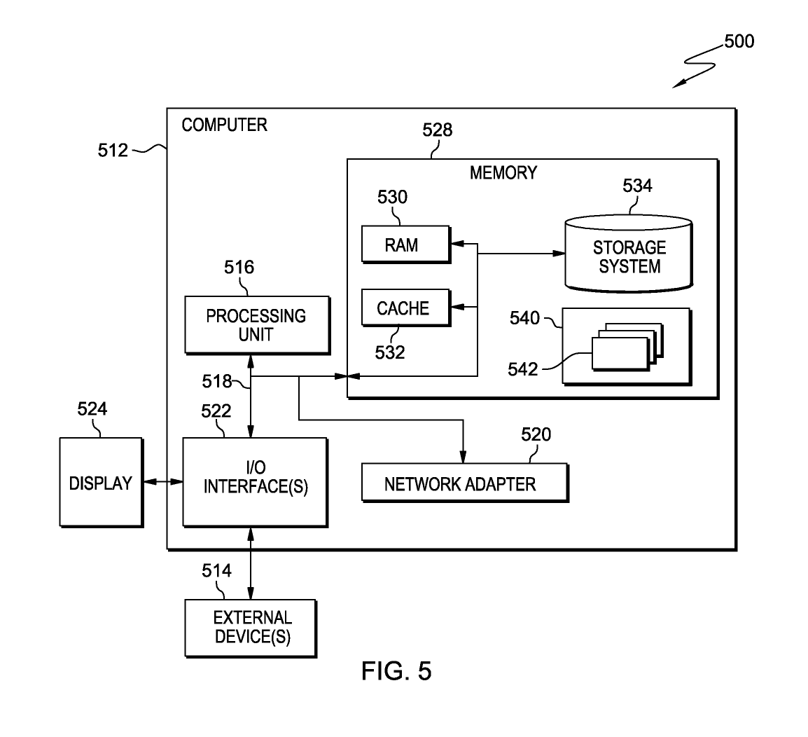

In various embodiments, each one of computing device 120 and software development server 130 can include a laptop, tablet, or netbook personal computer (PC), a desktop computer, a personal digital assistant (PDA), a smart phone, a mainframe computer, or a networked server computer. Further, software development server 130 can include computing systems utilizing clustered computers and components to act as single pools of seamless resources through network 110, or can represent one or more cloud computing datacenters. In general, each one of computing device 120 and software development server 130 can be any programmable electronic device as described in further detail with respect to FIG. 5. In one embodiment, the current technique can be implemented entirely in one device, such as computing device 120.

Software development server 130 includes application lifecycle management (ALM) program 132 for managing the development of a software application (i.e., for managing a software development project), as well as time stamp records 136 and monitoring program 134. ALM program 132 provides a representation of “workflow artifacts” in a software development project as well as the linkages between the workflow artifacts. Further, ALM program 132 records time stamps in time stamp records 136 as the representation changes. The representation and the time stamps can be collectively regarded as application lifecycle management data. A change to the representation can include, but is not limited to, the creation and deletion of a workflow artifact, its linkage to another workflow artifact, and the accomplishment of a task related to the workflow artifact.

Generally, a workflow artifact in a software development project can be any task to be accomplished during the course of the software development project, for instance, a requirement or a test execution. A linkage between workflow artifacts in a software development project can be any relationship between tasks in the software development project, for instance, the relationship between a plan item and a requirement. As work is performed during the course of the software development project, time stamps can be recorded for both the substantive work as well as for the administrative work of maintaining and updating the representation.

Monitoring program 134 analyzes aspects of software development server 130, including time stamp records 136 and the representation of the software development project, to generate value stream map 122, lag time visualizations 124, and waste reduction visualization 126, for increasing efficiency and reducing lag time in the software development project, as discussed in further detail below.

Computing device 120 includes a client program (not shown) for interacting with software development server 130 via network 110. In particular, the client program can interact with ALM program 132 or monitoring program 134 to display value stream map 122, lag time visualizations 124, and waste reduction visualization 126. Although FIG. 1 depicts only computing device 120 connecting to software development server 130, in various embodiments any number of computing devices, each supporting a client program, can connect to software development server 130.

Monitoring program 134, which in a preferred embodiment resides on software development server 130, analyzes time stamp records 136 and the representation of the software development project provided by ALM program 132. Monitoring program 134 can be a tool within ALM program 132 or it can be a separate program. As previously stated, ALM program 132 provides a representation of workflow artifacts in a software development project as well as linkages between workflow artifacts. The workflow artifacts and linkages between workflow artifacts determine the flow of information in a software development project. The determined flow of information in a software development project involves aspects of when and how particular work to be performed depends on prior work, and aspects of when and how future work is performed.

Software development projects are often very large and very complex involving collaboration and communication between a large number of people, departments, groups, or teams (generally referred to herein as “teams”). Often these teams operate remotely, residing in different buildings, locations, or countries. A single software development project can span numerous teams across numerous locations. One team may be developing requirements while another team in another location is developing plan items, and a third team is writing test scripts in another country. Inefficiency and waste are introduced to the software development project as a result of the numerous information hand-offs required between the variety of teams and the variety of locations. Inefficiency and waste increase as the size and the scope of the project increase. It is management's responsibility to monitor the schedule and progress of the software development project, and a manager will typically monitor multiple development projects running concurrently. In this large and diverse software development environment, the efficiency or timeliness of communication and collaboration between people, departments, groups, or teams can be measured by the lag time introduced to the schedule. By monitoring the lag time resultant from the handoff of information from one workflow artifact to another, or resultant from delays during the performance of a single workflow artifact, inefficiencies can be found and corrected.

For example, if a given workflow artifact is completed on Mar. 3, 2013 at 8:00, and the next workflow artifact is started on Sep. 15, 2013 at 15:00, then a lag time of 6 months, 12 days, and 7 hours has been introduced as a result of the handoff of information between this pair of workflow artifacts. Monitoring program 134 continues to analyze the timestamp data, determining the lag times present throughout the entire software development project. Further, monitoring program 132 can compile the lag time data providing, for example, individual performance, team performance, average lag times for different teams, or average lag time for an organization in the software development project that can be visualized and compared. This can provide insight by showing which people, departments, groups, or teams have the highest or lowest efficiency and facilitate improvement by the adoption of the best practices of the most efficient people, departments, groups, or teams. Performance is analyzed by monitoring program 132 throughout the entire software development project, providing visualization of the lag times and to determine if there have been improvements in efficiency or to determine the impact of implemented changes.

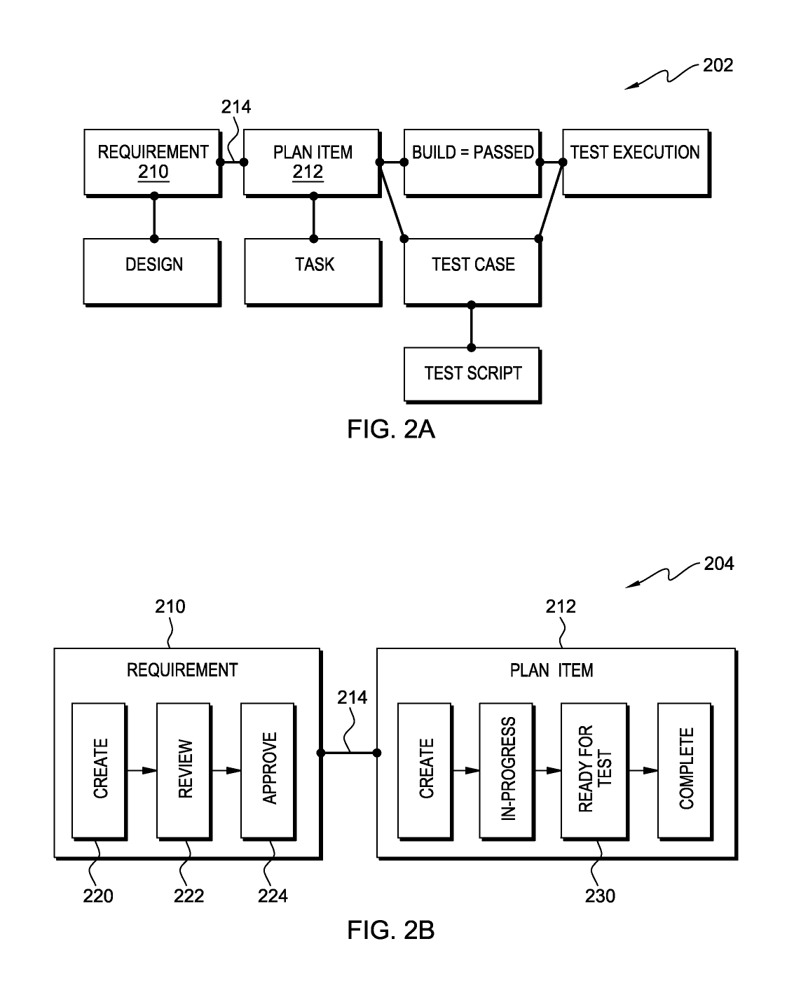

FIGS. 2a and 2b show block diagrams of software workflows 202 and 204 in accordance with an embodiment of the present invention. Each of software workflows 202 and 204 is a representation of a software development project. FIG. 2a shows an exemplary block diagram of software development workflow 202 illustrating various workflow artifacts and their linkages. For example, requirement 210 is a workflow artifact that defines a set of requirements of the software development project. Further, plan item 212 is a workflow artifact that creates a software item (i.e. program code) in preparation for test. Linkage 214 exists between plan item 212 and requirement 210. Linkage 214 is presented as an example, and similar linkages exist throughout software development workflow 202. FIG. 2b shows a subset of workflow 202 and is an exemplary block diagram illustrating that “states” can exist within a workflow artifact. States can be any task to be accomplished within a workflow artifact. Time stamps associated with state changes are recorded as time stamp records 136 and are included in the application lifecycle management data. In this example, requirement 210 includes three states; create 220, review 222, and approve 224.

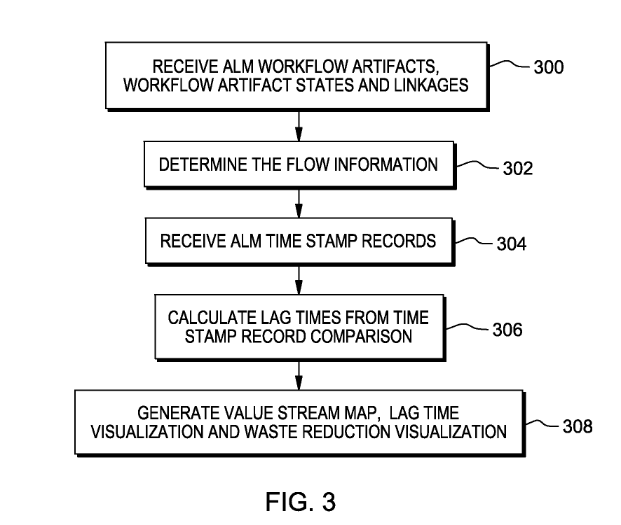

FIG. 3 is a flowchart showing the operational steps of monitoring program 134 in accordance with an embodiment of the present invention. Monitoring program 134 analyzes software development workflow 202, by receiving the workflow artifacts, workflow artifact states, and linkages from ALM program 132 (step 300). Monitoring program 134 uses the workflow artifacts, workflow artifact states, and linkages to determine the flow of information for the software development project (step 302). As previously stated, ALM program 132 also provides time stamp records 136 as the state of the workflow artifacts change. Monitoring program 134 receives time stamp records 136 from ALM program 132 (step 304). These time stamp records are used to calculate lag times present in the flow of information. A time stamp record is created as a workflow artifact or state is completed. A time stamp record is also created when the next workflow artifact or state in the flow of information is started. A time stamp record is further created when a workflow artifact or linkage is created or removed from software development workflow 202. Monitoring program 134 compares these time stamp records and calculates the lag time as the difference between each pair of time stamps (step 306). The pair of time stamps can be within a single workflow artifact. For example, a time stamp record for the completion of create 220 is recorded as Mar. 5, 2013-10:00, and a time stamp record for the completion of approve 224 is recorded a Mar. 8, 2013-16:00. The lag time, the difference between this pair of time stamps, is 78 hours. Further, the pair of time stamps can be in different workflow artifacts, for example, between the time stamp record for the completion of create 220 and the time stamp record for the start of ready for test 230. Still further, the pair of time stamps can be between the time stamp records for a state and a linkage, for example between the time stamp record for the completion of create 220 and the time stamp record for the creation of linkage 214. When a time stamp record has not been created for the start of the next workflow artifact or state, the monitoring program 134 can use the present time for the comparison to determine a running lag time. Monitoring program 134 uses the flow of information from step 302 and the lag times from step 306 to generate visualizations (step 308). Examples of these visualizations include, but are not limited to, value stream map 122, lag time visualizations 124, and waste reduction visualizations 126.

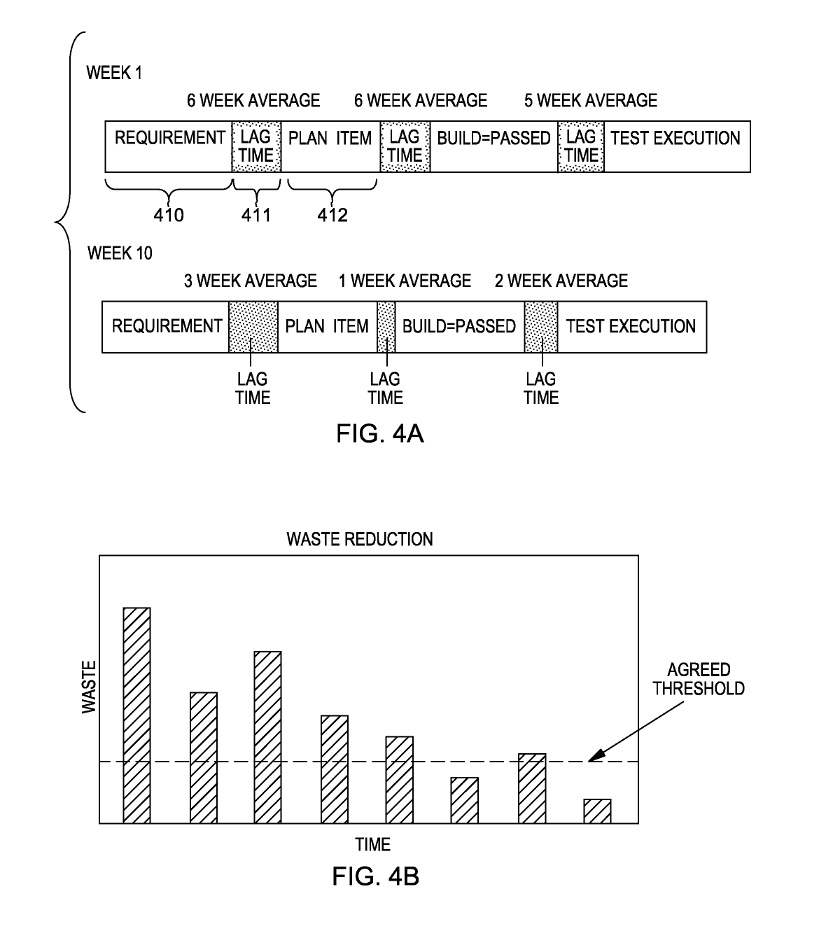

FIGS. 4a and 4b show example visualizations generated by monitoring program 134 in accordance with an embodiment of the present invention. FIG. 4a shows an example of a lag time visualization depicted as lag time visualization 124 in FIG. 1. Requirement 410 is a visual representation of the duration of requirement 210 in FIG. 2a, and plan item 412 is a visual representation of, the duration of plan item 212 in FIG. 2a. Lag time 411 is a visual representation of the duration of lag time determined by monitoring program 134, by comparing the time stamp record for the completion of requirement 210 and the time stamp record for the start of plan item 212.

As further shown in FIG. 4a, the average lag time for a given team is compared for two separate time periods, in this case, week 1 versus week 10, to determine if there have been improvements in efficiency, perhaps due to the impact of implemented changes.

FIG. 4b shows an example of a waste reduction visualization depicted as waste reduction visualization 126 in FIG. 1. Waste, the lag time resultant from the handoff of information, is plotted to show incremental improvements in waste over time and may include an efficiency goal or agreed threshold. This agreed threshold acknowledges that an increment of time is necessary for the handoff of information.

FIGS. 4a and 4b are presented as exemplary visualizations. FIG. 4a depicts a visualization showing a comparison of a single team at two separate times. A further visualization (not shown) can be generated showing a comparison of lag times of at least two different teams allowing for the comparison of the performance of one team to the performance of other teams. These comparisons can be during a single time period or across multiple time periods. In a further example, a visualization of the average lag time of a team can be generated spanning multiple time periods (not shown). The averages of one can be combined with averages of other teams to determine the performance characteristics of an organization.

Monitoring program 134 can generate visualizations that can depict lag time or lag time averages across all levels of a software development project. The visualizations can depict the performance of an individual. Further, the visualizations can depict the performance of a single team, encompassing the individual team members or the visualizations can depict the performance for a project, encompassing the individual teams. The visualizations from one software development project can also be compared to the visualizations of other software development projects within an organization to determine the performance characteristics of the organization.

Referring now to FIG. 5, a block diagram of a computer system in accordance with an embodiment of the present invention is shown. Computer system 500 is only one example of a suitable computer system and is not intended to suggest any limitation as to the scope of use or functionality of embodiments of the invention described herein. Regardless, computer system 500 is capable of being implemented and/or performing any of the functionality set forth hereinabove.

In computer system 500 there is computer 512, which is operational with numerous other general purpose or special purpose computing system environments or configurations. Examples of well-known computing systems, environments, and/or configurations that may be suitable for use with computer 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of computing device 120 and software development server 130 can include or can be implemented as an instance of computer 512.

Computer 512 may be described in the general context of computer system executable instructions, such as program modules, being executed by a computer system. Generally, program modules may include routines, programs, objects, components, logic, data structures, and so on that perform particular tasks or implement particular abstract data types. Computer 512 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 5, computer 512 in computer system 500 is shown in the form of a general-purpose computing device. The components of computer 512 may include, but are not limited to, one or more processors or processing units 516, memory 528, and bus 518 that couples various system components including memory 528 to processing unit 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 512 typically includes a variety of computer system readable media. Such media may be any available media that is accessible by computer 512, and includes both volatile and non-volatile media, and removable and non-removable media.

Memory 528 can include computer system readable media in the form of volatile memory, such as random access memory (RAM) 530 and/or cache 532. Computer 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program 540, having one or more program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. ALM program 132 and monitoring program 134 can each be implemented as or can be an instance of program 540.

Computer 512 may also communicate with one or more external devices 514 such as a keyboard, a pointing device, etc., as well as display 524; one or more devices that enable a user to interact with computer 512; and/or any devices (e.g., network card, modem, etc.) that enable computer 512 to communicate with one or more other computing devices. Such communication can occur via Input/Output (I/O) interfaces 522. Still yet, computer 512 can communicate with one or more networks such as a local area network (LAN), a general wide area network (WAN), and/or a public network (e.g., the Internet) via network adapter 520. As depicted, network adapter 520 communicates with the other components of computer 512 via bus 518. It should be understood that although not shown, other hardware and/or software components could be used in conjunction with computer 512. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for analyzing application lifecycle management data, the method comprising:
a computer receiving application lifecycle management (ALM) data, wherein the ALM data includes a plurality of workflow artifacts each having at least one state, at least one linkage between two of the plurality of workflow artifacts, and a plurality of time stamps each associated with the at least one linkage or with one of the plurality of workflow artifacts; and
the computer calculating a lag time between two of the plurality of time stamps of the ALM data.

2. The method of claim 1, further comprising:
generating a visualization based at least on the calculated lag time.

3. The method of claim 2, wherein the visualization includes a value stream map, a lag time visualization, or a waste reduction visualization.

4. The method of claim 2, wherein the visualization compares a same one of a team utilizing the ALM, at separate time periods.

5. The method of claim 1, wherein the calculated lag time is between the time stamp of at least one state and the time stamp of at least one linkage.

6. The method of claim 2, wherein the visualization includes the average of at least two lag times.

7. The method of claim 2, wherein the visualization compares at least two teams utilizing the ALM.
